(19) United States
(12) Patent Application Publication
(10) Pub. No.: US 2026/0365361 A1
(43) Pub. Date: Nov. 19, 2026

(54) LABEL CUTTING DEVICE AND LABELING DEVICE

(71) Applicant: Krones AG, Neutraubling (DE)

(72) Inventors: Roland KERSCHNER, Regensburg (DE); Nicolas NUEBEL, Regensburg (DE)

(21) Appl. No.: 19/676,423

(22) Filed: May 13, 2026

(30) Foreign Application Priority Data
May 15, 2025 (DE) 102025118876.9

(51) Int. Cl. B65C 9/18; B26D 7/18; B65C 9/40

(52) U.S. Cl. CPC B65C 9/1819; B26D 7/1854; B65C 9/40

(57) ABSTRACT

A label cutting device for cutting labels for containers, includes a counter-cutting roller for cutting a label by engaging with a cutting roller; and a cleaning apparatus including a compressed air apparatus arranged to apply compressed air to the counter-cutting roller.

### CROSS-REFERENCE TO RELATED APPLICATION AND PRIORITY CLAIM

This application claims priority to German Patent Application No. 102025118876.9, filed May 15, 2025, the disclosure of which is incorporated herein by reference in its entirety.

### TECHNICAL FIELD

The present invention relates to a label cutting device and to a labeling device.

### BACKGROUND

Label cutting devices for beverage container labels are known in the prior art. In these label cutting devices, labels are separated by cutting, for example, continuous or cut-to-length label tapes. It is known to carry out such label cutting by using a pair of rollers. In this process, a counter-cutting roller, which can support the labels, engages with a cutting roller, thereby cutting a label.

### SUMMARY

With these label cutting devices, contamination of the counter-cutting roller can occur during the cutting process. In particular, label particles resulting from the cutting process can accumulate on the counter-cutting roller. Furthermore, dirt can accumulate on the counter-cutting roller due to a relative movement between the counter-cutting roller and the label.

With conventional label cutting devices, cleaning can therefore be very time-consuming and is usually done manually to ensure the desired label quality.

It is therefore an object of the present invention to provide a label cutting device with which the efficiency of the label cutting device can be increased while ensuring sufficient quality of the labels.

This object is achieved according to the invention described in this disclosure.

According to one aspect disclosed herein, a label cutting apparatus for cutting labels for containers, in particular beverage containers, is provided, comprising: a counter-cutting roller for cutting a label by engagement with a cutting roller; and a cleaning apparatus comprising a compressed air apparatus arranged to apply compressed air to the counter-cutting roller.

According to this aspect, it is possible to reduce manual cleaning of the counter-cutting roller, in particular to eliminate it entirely, which can increase the efficiency of the label cutting device. In this way, a standstill of the label cutting device due to necessary cleaning can be avoided. Furthermore, errors in the cutting process resulting from contamination of the counter-cutting roller can be reduced, and in particular avoided. Downtime due to such errors can also be reduced or avoided in this way. It has been shown that the compressed air can reliably remove dirt from the counter-cutting roller. In particular, even small dirt particles can be reliably removed.

In this disclosure, cutting comprises any form of separation of a label, in particular from a label tape, by engagement of the counter-cutting roller and cutting roller. The invention is not limited to one type of separation. Cutting can thus comprise actual cutting under shear forces, crushing, pressing, tearing, etc.

Compressed air can be understood here to mean any gaseous fluid, but, in particular, air that is put under pressure. The static pressure occurring in the compressed air can be, in particular, higher than atmospheric pressure, furthermore at least 2 bar, and furthermore at least 5 bar.

Labels for container are understood to mean labels that are applied to containers, in particular, beverage containers. They can be coated with adhesive after cutting. The labels can, in particular, show information about the contents of the container, and, for example, can be printed with this information. They can be made of materials such as cellulose or plastic.

The beverage container can be, for example, a bottle.

The cleaning apparatus can also comprise an extraction apparatus arranged to extract dirt from the counter-cutting roller.

This can reliably prevent dirt, which is loosened from the counter-cutting roller by the compressed air, from entering the environment. The dirt can be collected, for example, in a collecting tank of the cleaning apparatus. The cleaning performance can thus be further increased. Alternatively or additionally, the cleaning apparatus, in particular, the extraction apparatus, can comprise a filter that separates the dirt from the extraction stream.

In particular, the extraction apparatus can have a volume flow amplifier based on the Venturi effect.

This allows for simple extraction. In particular, the need for complex blowers can be eliminated.

Alternatively or additionally, the extraction apparatus and the compressed air apparatus can be configured as an integral unit.

This allows for a compact configuration of the cleaning apparatus. In particular, the compressed air apparatus and the extraction apparatus can be moved integrally and attached to each other. They can be arranged directly next to each other.

The compressed air apparatus can be arranged to apply compressed air to the counter-cutting roller in a radial direction.

This makes it possible to apply relatively high energy to the counter-cutting roller and thus reliably loosen the dirt. Furthermore, the impact on the environment can be kept small compared to tangential application.

The compressed air apparatus can be configured such that compressed air can be applied selectively to the counter-cutting roller portion by portion in an axial direction of the counter-cutting roller.

This allows the compressed air to be applied to the roller in a concentrated manner in specific axial portions, which promotes the removal of dirt. “Selectively” here means that compressed air can be applied to a plurality of portions in parallel or even to just one portion.

The compressed air apparatus can have a plurality of outlet openings in an axial direction of the counter-cutting roller.

This allows the compressed air to be bundled in axial portions. The removal of dirt can thus be further improved. This configuration is advantageous, in particular, in case of selective application.

Furthermore, the compressed air apparatus can have a plurality of air supplies.

This allows compressed air to be applied to the counter-cutting roller with sufficient energy, which further supports the cleaning process. In particular, at least one air supply can be assigned to each outlet opening.

The compressed air apparatus can be configured such that compressed air can be applied to the counter-cutting roller substantially over its entire axial length.

This allows for comprehensive cleaning of the counter-cutting roller. In particular, the compressed air apparatus can be fixed in a position to clean the entire counter-cutting roller.

The extraction apparatus can also be configured to extract dirt over substantially the entire axial length. It can also be fixed in one position.

The counter-cutting roller can have a cutting edge on an outer side.

The cutting roller can engage with this cutting edge in order to cut the label. Dirt can easily adhere to the cutting edge, which is why the invention is particularly advantageous in this embodiment. The cutting edge can extend at least in portions, in particular, substantially over its entire axial length, along an axial direction.

The counter-cutting roller can have a cutting gap on an outer side extending in an axial direction.

A blade of the cutting roller can engage with this cutting gap. However, such a cutting gap can lead to the accumulation of dirt. Therefore, providing a compressed air apparatus is particularly advantageous.

Furthermore, a gap seal can be provided between a position of compressed air application and a cutting position of the counter-cutting roller. This prevents compressed air from reaching the cutting position.

The counter-cutting roller can have at least one suction opening on an outer side, through which the label can be drawn onto the counter-cutting roller.

This allows the label to be supported by the counter-cutting roller before and/or after cutting, so that it adheres to the counter-cutting roller and can be passed on to subsequent apparatuses in a controlled manner. However, the suction opening is particularly susceptible to dirt. A blocked suction opening can disrupt the cutting process in the long run. Therefore, the invention is particularly advantageous here.

The counter-cutting roller can further have at least one groove extending in a circumferential direction on an outer side.

Such a groove can accumulate dirt as well. This makes the invention particularly advantageous here. In particular, the groove can be in communication with the cutting gap. The at least one groove can be provided in an axial direction between a plurality of suction openings.

At least the compressed air apparatus can be moved between a cleaning position, in which it is arranged to apply compressed air to the counter-cutting roller, and a standby position, in which it is removed from the counter-cutting roller.

Therefore, the compressed air apparatus can be moved into the cleaning position only when it is actually needed for cleaning. If cleaning is not necessary, the cutting process can be carried out without disruption.

The label cutting apparatus can further comprise: an electronic control unit programmed to control the cleaning apparatus such that compressed air is applied to the counter-cutting roller while a cutting process is being carried out on the labels or while no cutting process is being carried out on the labels.

The first alternative allows for better utilization of the label cutting device. The second alternative makes it possible to carry out the cleaning process and the cutting process separately, and thus without any disruptions. In the second alternative, the electronic control unit can control the counter-cutting roller such that it is rotated, in particular, at least once completely, while compressed air is being applied. This allows the counter-cutting roller to be completely cleaned in the circumferential direction. However, the counter-cutting roller can also be idle. In both alternatives, the compressed air apparatus can be arranged such that compressed air application takes place at a position spaced away from the cutting position, for example offset by a circumferential angle of 180°.

The electronic control unit can also be programmed to control the cleaning apparatus such that the compressed air apparatus and the extraction apparatus apply compressed air to the counter-cutting roller at least temporarily in parallel and extract dirt therefrom.

According to a further aspect, a labeling apparatus for containers is provided, comprising: the label cutting apparatus according to at least a portion of the above; and a transfer apparatus for transferring the label to a container.

This allows a label for a container, in particular, a beverage container, to be provided efficiently and with high quality. The labeling device can be part of a bottle manufacturing plant and/or a bottle filling plant.

### BRIEF DESCRIPTION OF THE DRAWINGS

The invention is described in detail below with reference to the drawings.

FIG. 1 schematically illustrates a label cutting device in a partially cutaway view;

FIG. 2 schematically illustrates a label cutting device in a partially cutaway view; and

FIG. 3 illustrates a perspective view of a cleaning apparatus.

### DETAILED DESCRIPTION

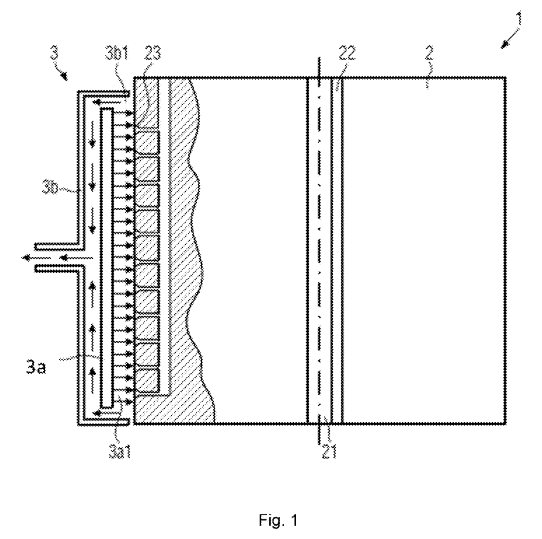

FIG. 1 shows a label cutting device 1. The label cutting apparatus 1 comprises a counter-cutting roller 2 and a cleaning apparatus 3.

The counter-cutting roller 2 has a substantially cylindrical shape. One axis of the counter-cutting roller 2 defines an axial direction. In a circumferential portion of the counter-cutting roller 2, a cutting edge 21 is provided, which is exposed to the outer side and extends substantially over the entire axial length of the counter-cutting roller 2. The cutting edge 21 can protrude with respect to an outer circumferential surface of the counter-cutting roller. However, it can also be provided to be flush with the outer circumferential surface.

A cutting knife of a cutting roller can squeeze a label tape, which will be written on later, on the cutting edge, thereby separating a label. The cutting position can be located on the cutting edge 21 in the center of the circumferential direction.

The counter-cutting roller 2 also has a plurality of suction openings 23 in the outer circumferential surface. The suction openings 23 are spaced apart from each other in the circumferential direction and in the axial direction. The suction openings are connected to a main channel via a plurality of branch channels, to which a vacuum can be applied.

The cleaning apparatus 3 is spaced apart from the counter-cutting roller 2 in the radial direction. The cleaning apparatus 3 has a compressed air apparatus 3a. The compressed air apparatus 3a has an air supply (not shown) and an outlet opening 3a1, which extends substantially over the entire axial length of the counter-cutting roller 2, at least over the axial region in which the plurality of suction openings 23 are provided. Through the outlet opening 3a1, a jet of compressed air is directed onto the counter-cutting roller 2 substantially parallel to the radial direction.

It should be noted that the compressed air can, in particular, cover a circumferential angle of at most 10°, furthermore, in particular, at most 5°.

Here, the compressed air apparatus 3a is configured as an integral unit with an extraction apparatus 3b. They are attached to each other. The extraction apparatus 3b encompasses the compressed air apparatus in the axial direction and advantageously also in the circumferential direction. In other words, an axial dimension and circumferential dimension of an inlet opening 3b1 of the extraction apparatus 3b is larger than that of the outlet opening 3a1. An outer housing of the extraction apparatus 3b accommodates the compressed air apparatus 3a inside.

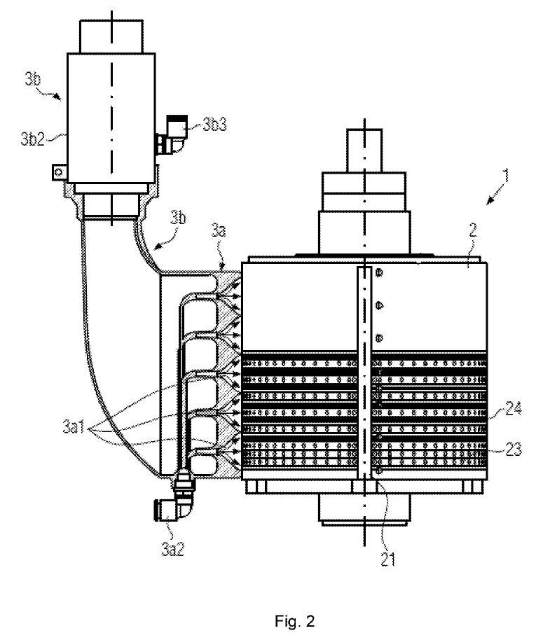

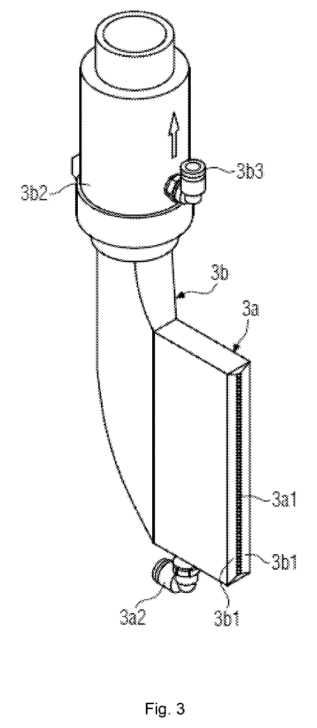

FIG. 2 and 3 show a modified embodiment of the label cutting apparatus 1, wherein only the cleaning apparatus 3 is configured differently. However, details of the counter-cutting roller 2 of FIG. 2, which are not shown in FIG. 1, are also present in the embodiment of FIG. 1.

FIG. 2 further shows that a plurality of grooves 23 run in the circumferential direction in the outer circumferential surface of the counter-cutting roller 2. The grooves 23 can each be in communication with the cutting edge 21.

In FIG. 2, the cleaning apparatus 3 is also radially spaced from the counter-cutting roller 2 and applies compressed air to the counter-cutting roller 2 in a radial direction. However, five outlet openings 3a1 arranged side by side in the axial direction are provided here, each applying compressed air to different axial portions of the counter-cutting roller 2. A common air supply 3a2 directs the compressed air to all outlet openings 3a1. The air supply 3a2 is arranged below the outlet openings 3a1, through which the compressed air is directed onto the counter-cutting roller 2 substantially parallel to the radial direction.

As shown in FIG. 3, an inlet opening 3b1 of the extraction apparatus 3b is provided on both sides of the outlet openings 3a1 in the circumferential direction. The outlet opening 3a1 and the inlet openings 3b1 each extend in an axial direction substantially over the entire length of the counter-cutting roller 2.

The extraction apparatus 3b has a volume flow amplifier 3b2 based on the Venturi principle downstream of a bend. The volume flow amplifier 3b2 is supplied with compressed air from an extraction compressed air supply 3b3.

The functions and effects of the above embodiments are described below.

A continuous label tape can adhere to the counter-cutting roller 2 via the suction openings 23. It covers the cutting edge 21. When the counter-cutting roller 2 now engages with a blade/knife of a cutting roller opposite the counter-cutting roller 2 through synchronized rotation of the rollers, the label tape is cut, and a label is cut, in particular, by squeezing. The cut label continues to be held against the counter-cutting roller 2 by the suction openings 23. When the vacuum is removed via the suction openings 23, the label can be transferred to a subsequent apparatus.

Cutting can lead to dirt on the counter-cutting roller 2, in particular, on the cutting edge 21, in the grooves 24 and the suction openings 23.

The counter-cutting roller can be configured such that the label tape moves relative to the counter-cutting roller before the cutting process and/or the cut label moves relative to the counter-cutting roller after the cutting process. In particular, the label tape and/or the label can rub against the counter-cutting roller 2. This can further promote contamination.

Since the compressed air apparatus 3a is provided, it is possible to reduce manual cleaning of the counter-cutting roller 2, in particular, to eliminate it entirely, which can increase the efficiency of the label cutting device 1. Compressed air can be understood here to mean any gaseous fluid, but, in particular, air, that is put under pressure. The static pressure occurring in the compressed air can be, in particular, higher than atmospheric pressure, furthermore at least 2 bar, and furthermore at least 5 bar.

The extraction apparatus 3b is furthermore provided.

Thus, the dirt loosened or removed from the counter-cutting roller 2 can be extracted. The dirt can be collected, for example, in a collecting tank of the cleaning apparatus. The cleaning performance can thus be further increased.

The extraction apparatus 3b and the compressed air apparatus 3a are configured as an integral unit.

This allows for a compact configuration of the cleaning apparatus 3, wherein the inlet opening 3b1 and the outlet opening 3b2 are arranged directly next to each other in the axial and/or circumferential direction.

In particular, the at least one inlet opening can at least partially surround the at least one outlet opening.

The compressed air apparatus 3a is arranged to apply compressed air to the counter-cutting roller 2 in a radial direction of the counter-cutting roller 2.

This makes it possible to apply relatively high energy to the counter-cutting roller 2 and thus reliably loosen the dirt. Furthermore, the impact on the environment can be kept small compared to tangential application.

The compressed air apparatus 3a has a plurality of outlet openings 3a1 in an axial direction of the counter-cutting roller 2.

This allows the compressed air to be bundled in axial portions in each case. The removal of dirt can thus be further improved.

The compressed air apparatus 3a is configured such that compressed air can be applied to the counter-cutting roller 2 substantially over its entire axial length.

This allows for comprehensive cleaning of the counter-cutting roller 2. In particular, the compressed air apparatus can be fixed in a position to clean the entire counter-cutting roller.

The extraction apparatus 3b is also configured to extract dirt over substantially the entire axial length. It can also be fixed in one position.

Furthermore, the following features can be provided either as an alternative or in addition to the above.

The compressed air apparatus and/or the extraction apparatus, in particular, the cleaning apparatus, can be moved between a cleaning position, in which it is arranged to apply compressed air to the counter-cutting roller, and a standby position, in which it is removed from the counter-cutting roller. A pivot mechanism can be provided for this purpose, for example.

Therefore, the compressed air apparatus can be moved into the cleaning position only when it is actually needed for cleaning. If cleaning is not necessary, the cutting process can be carried out without disruption.

However, the compressed air apparatus and/or the extraction apparatus can also be fixed.

A common air supply 3a2 was presented above. However, a plurality of air supplies, at least one for each outlet opening 3a1, can be provided.

Thus, by individually controlling the respective air supply, compressed air can be selectively applied to portions in the axial direction. However, such selective application is also possible using a variable aperture that can divide an outlet opening into a plurality of portions.

The label cutting device can further comprise: an electronic control unit programmed to control the cleaning apparatus 3 such that compressed air is applied to the counter-cutting roller while no cutting process is being carried out on the labels.

This makes it possible to carry out the cleaning process and the cutting process separately, and thus without any disruptions. In this process, the electronic control apparatus can control the counter-cutting roller such that it is rotated, in particular, at least once completely, while compressed air is being applied. This allows the counter-cutting roller to be completely cleaned in the circumferential direction.

Alternatively, the electronic control unit can control the cleaning apparatus and the counter-cutting roller such that compressed air is applied to the counter-cutting roller while a cutting process is being carried out on the labels.

The electronic control unit can also be programmed to control the cleaning apparatus 3 such that the compressed air apparatus 3a and the extraction apparatus 3b apply compressed air to the counter-cutting roller 2 at least temporarily in parallel and extract dirt therefrom. This allows dirt to be collected reliably.

The label cutting device 1 can be provided in a labeling device.

The at least one outlet opening or the plurality thereof and/or the at least one inlet opening or the plurality thereof need not be provided over the entire axial length. The axial extent can, in particular, coincide with a cutting region in the axial direction or a region where the suction openings are provided.

A case was described in which the labels are cut by squeezing them between a cutting edge and a knife of the cutting roller. However, a cutting gap may be provided in the outer circumferential surface of the counter-cutting roller, which extends substantially over the entire axial length of the counter-cutting roller. A knife of the cutting roller can engage in this cutting gap for cutting. The invention can be applied here as well.

What is claimed is:

1. A label cutting device for cutting labels for containers, comprising:
a counter-cutting roller for cutting a label by engaging with a cutting roller; and
a cleaning apparatus comprising a compressed air apparatus arranged to apply compressed air to the counter-cutting roller.

2. The label cutting device according to claim 1, wherein the cleaning apparatus further comprises an extraction apparatus arranged to extract dirt from the counter-cutting roller.

3. The label cutting device according to claim 2, wherein the extraction apparatus has a volume flow amplifier based on the Venturi effect.

4. The label cutting device according to claim 2, wherein the extraction apparatus and the compressed air apparatus are configured as an integral unit.

5. The label cutting device according to claim 1, wherein the compressed air apparatus is arranged to apply compressed air to the counter-cutting roller in a radial direction of the counter-cutting roller.

6. The label cutting device according to claim 1, wherein the compressed air apparatus is configured to apply compressed air selectively to the counter-cutting roller portion-by-portion in an axial direction of the counter-cutting roller.

7. The label cutting device according to claim 1, wherein the compressed air apparatus has a plurality of outlet openings in an axial direction of the counter-cutting roller.

8. The label cutting device according to claim 1, wherein the compressed air apparatus has a plurality of air supplies.

9. The label cutting device according to claim 1, wherein the compressed air apparatus is configured to apply compressed air to the counter-cutting roller substantially over an entire axial length of the counter-cutting roller.

10. The label cutting device according to claim 1, wherein the counter-cutting roller has a cutting edge on an outer side.

11. The label cutting device according to claim 1, wherein the counter-cutting roller has at least one suction opening on an outer side, through which the label can be drawn onto the counter-cutting roller.

12. The label cutting device according to claim 1, wherein the counter-cutting roller has at least one groove extending in a circumferential direction on an outer side.

13. The label cutting device according to claim 1, wherein:
the compressed air apparatus is movable between a cleaning position and a standby position;
in the cleaning position, the compressed air apparatus is arranged to apply compressed air to the counter-cutting roller; and
in the standby position, the compressed air apparatus is removed from the counter-cutting roller.

14. The label cutting device according to claim 1, further comprising:
an electronic control unit programmed to control the cleaning apparatus such that compressed air is applied to the counter-cutting roller while a cutting process is being carried out on the labels, or while no cutting process is being carried out on the labels.

15. The label cutting device according to claim 1, wherein the containers are beverage containers.

16. A labeling device for containers, comprising:
a label cutting device for cutting labels for the containers, wherein the label cutting device comprises:
a counter-cutting roller for cutting a label by engaging with a cutting roller; and
a cleaning apparatus comprising a compressed air apparatus arranged to apply compressed air to the counter-cutting roller; and
a transfer apparatus for transferring the label to a container.

17. The labeling device according to claim 16, wherein the cleaning apparatus further comprises an extraction apparatus arranged to extract dirt from the counter-cutting roller.

18. The labeling device according to claim 16, wherein the compressed air apparatus is arranged to apply compressed air (1) to the counter-cutting roller in a radial direction of the counter-cutting roller, or (2) selectively to the counter-cutting roller portion-by-portion in an axial direction of the counter-cutting roller.

19. The labeling device according to claim 16, wherein:
the compressed air apparatus is movable between a cleaning position and a standby position;
in the cleaning position, the compressed air apparatus is arranged to apply compressed air to the counter-cutting roller; and
in the standby position, the compressed air apparatus is removed from the counter-cutting roller.

20. The labeling device according to claim 16, wherein the label cutting device further comprises:
an electronic control unit programmed to control the cleaning apparatus such that compressed air is applied to the counter-cutting roller while a cutting process is being carried out on the labels, or while no cutting process is being carried out on the labels.
